(19) United States
(12) Patent Application Publication
(10) Pub. No.: US 2003/0101856 A1
(43) Pub. Date: Jun. 5, 2003

(54) Tool and method for removing a cut off PEX tubing end from an insert fitting

(76) Inventor: Mark A. Monson, Lake Lure, NC (US)

Correspondence Address: STEVEN C. SCHNEDLER, CARTER & SCHNEDLER, PA, 56 CENTRAL AVE., SUITE 101, PO BOX 2985, ASHEVILLE, NC, 28802, US

(21) Appl. No.: 10/262,690

(22) Filed: Oct. 2, 2002

Related U.S. Application Data
(63) Continuation-in-part of application No. 10/200,657, filed on Jul. 22, 2002.
(60) Provisional application No. 60/307,050, filed on Jul. 23, 2001.

(51) Int. Cl. B26B 17/00

(52) U.S. Cl. 83/13; 30/193

(57) ABSTRACT

A tool and method for removing a cut-off end of a plastic pipe such as PEX tubing and a clamping ring from a pipe connection member or nipple of an insert fitting. The tool includes an anvil which is insertable into the connection member so as to face and bear against a connection member inner surface, and a wedge-shaped cutter operatively connected to and opposed to the anvil.

### CROSS-REFERENCE TO RELATED APPLICATION

The benefit of U.S. Provisional patent application Serial No. 60/307,050, filed Jul. 23, 2001, is claimed.

### BACKGROUND OF THE INVENTION

The invention relates generally to piping systems employing crosslinked polyethylene (PEX) pipe or tubing in combination with insert fittings and, more particularly, to a tool and method for removing a cut-off PEX tubing end retained by a clamping ring such as a crimped brass ring from a connection member of the fitting so that the fitting can be reused.

Crosslinked polyethylene (PEX) tubing is employed in hot and cold water distribution systems in buildings, in radiant floor heating applications, and in other applications. PEX tubing is a form of plastic pipe, and is used in combination with insert fittings that are typically, but not necessarily, made of brass. PEX tubing and PEX fittings are available in sizes ranging from 1/4 inch to 2 inches in diameter. PEX is a thermoset by definition, but offers the flexibility and appearance of a thermoplastic. PEX is described in greater detail in a report titled “Crosslinked Polyethylene (PEX) Tubing TN-17/2001” published by the Plastics Pipe Institute, Washington, D.C. (http://www.plasticpipe.org).

Fittings employed in combination with PEX tubing include elbows and tees, as well as test cap fittings (closed end fittings) that are employed for pressure testing, and subsequently cut off. Each fitting includes at least one connection member or nipple in the form of a hollow cylinder with annular rings on the outside (also known as barbs). The connection member is pushed inside the end of the PEX tubing. A clamping ring is installed on the outside of the PEX tubing which squeezes and deforms the tubing over the annular rings for a secure, water-tight seal.

In a common system, a crimp tool is employed for installing a clamping ring in the form of an annealed brass ring over the PEX tubing, to form a crimped brass ring. Typical installation procedures are described in a document titled “DURA-PEX Installation Manual” published by Consolidated Plumbing Industries, of Knoxville, Tenn. (http://www.durapex.com).

There are other forms of clamping rings which can be employed. Thus, a PEX piping system that employs a plastic clamping ring rather than a crimped brass ring is manufactured by Wirsbo Systems (http://www.wirsbosystems.com). A tool suitable for use in installing the Wirsbo system is disclosed in Sörberg U.S. Pat. No. 5,744,085. Oetiker clamps are made of stainless steel, and a different tool is used for installation (http://www.oetiker.com).

Occasionally, a fitting must be removed from the end of a length of tubing. As an example, a crimp ring may be installed incorrectly. The plastic tubing can readily be cut off the fitting, leaving perhaps 3/4 inch of plastic tubing as a cut-off end (to be discarded) on the fitting. (Ordinarily there is sufficient length of tubing remaining for reconnection to another fitting, notwithstanding the 3/4 inch in length which has been lost.)

Although reusing the fitting in such a situation may appear to be an obvious and desirable thing to do, in practice it is difficult to remove a crimped annealed brass ring from the cut-off end of the PEX tubing. It is also difficult to remove the cut-off end of the PEX tubing itself from the fitting, particularly if damage to the fitting is to be avoided. PEX tubing, once it has been deformed by the crimped annealed brass ring, cannot simply be pulled off the fitting. The annular rings or barbs quite effectively lock the tubing to the fitting.

Moreover, any damage to the annular rings of the fitting presents a potential leakage path for water in the event the fitting is reused in a pressurized plumbing system. Manufacturers of PEX tubing plumping systems discourage reuse of the fittings.

Although not the result of mis-installation, a related situation occurs in the use of pressure test end caps. They are installed to the PEX tubing in the same manner and, after pressure testing, are cut off.

There are several common practices after a fitting is thus removed by cutting off, leaving a cut-off tubing end and the crimped annealed brass ring on the connection member or nipple. One practice is to simply discard the fitting. Another practice is to recycle the fittings as brass scrap without attempting to remove the crimp rings or cut-off plastic tube ends. As a third practice, in some cases, the crimp rings and deformed tube sections are removed, but with difficulty.

The removal of crimp rings and deformed plastic tube sections presents a number of difficulties. Commonly, the crimp rings are sawed off with a hacksaw. This can be quite awkward. In addition the deformed tubing cannot simply be pulled off a barbed brass fitting. Accordingly, the tubing end is cut off, typically using a knife to make a longitudinal cut. This is however difficult to do without nicking the barbs.

### SUMMARY OF THE INVENTION

In one embodiment, a tool is provided for removing a cut-off end of a plastic pipe and a clamping ring from a pipe connection member. The plastic pipe has pipe wall inner and outer surfaces, and the clamping ring has clamping ring inner and outer surfaces. The pipe connection member has a wall with a maximum radial wall thickness between connection member inner and outer surfaces, in other words, between the inside diameter of the connection member and the outer surface of the annular rings, also referred to as barbs.

The tool includes an anvil which is insertable into the connection member so as to face and bear against the connection member inner surface, and a wedge-shaped cutter operatively connected to and opposed to the anvil. The cutter is positionable outside the connection member so as to face the clamping ring outer surface. The cutter and the anvil are moveable relative to each other between an open position in which the cutter and the anvil are spaced from each other so as to clear the radial distance between the connection member inner surface and the clamping ring outer surface, and a closed position in which the cutter and the anvil are spaced from each other a radial distance such that the cutter cuts through the clamping ring and approaches but does not substantially cut into the connection member outer surface.

In another embodiment, the invention provides a method for removing a cut-off end of a plastic pipe and a clamping ring from a pipe connection member, as described above. A tool as summarized above is provided. The anvil is inserted into the connection member. The cutter and the anvil are moved relative to each other to the closed position so as to cut through the clamping ring.

### BRIEF DESCRIPTION OF THE DRAWINGS

FIG. 1 is an exterior view of a brass insert fitting in the form of a “tee” including three pipe connection members or nipples with a cut-off end of a plastic pipe and a clamping ring on one of the connection members;

FIG. 2 is an end view taken on line 2-2 of FIG. 1;

FIG. 3 is a cross-sectional view taken on line 3-3 of FIG. 1;

FIG. 4 depicts a tool in the form of a pliers embodying the invention;

FIGS. 5, 6 and 7 represent a sequence of operations in a method embodying the invention employing the tool of FIG. 4;

FIG. 8 depicts another tool embodying the invention, in the form of a compound lever pliers, shown in its open position;

FIG. 9 depicts the tool of FIG. 8 in a closed position;

FIG. 10 is an enlarged view of the anvil and cutter of the tool of FIGS. 8 and 9 in isolation;

FIG. 11 is an end view of the anvil and cutter taken on lines 11-11 of FIG. 10;

FIG. 12 depicts use of a tool embodying the invention applied to a pipe connection member having a relatively larger diameter; and

FIG. 13 depicts a tool embodying the invention applied to a pipe connection member having a relatively smaller diameter; and

FIG. 13A is an enlarged detail of a portion of FIG. 13.

### DETAILED DESCRIPTION

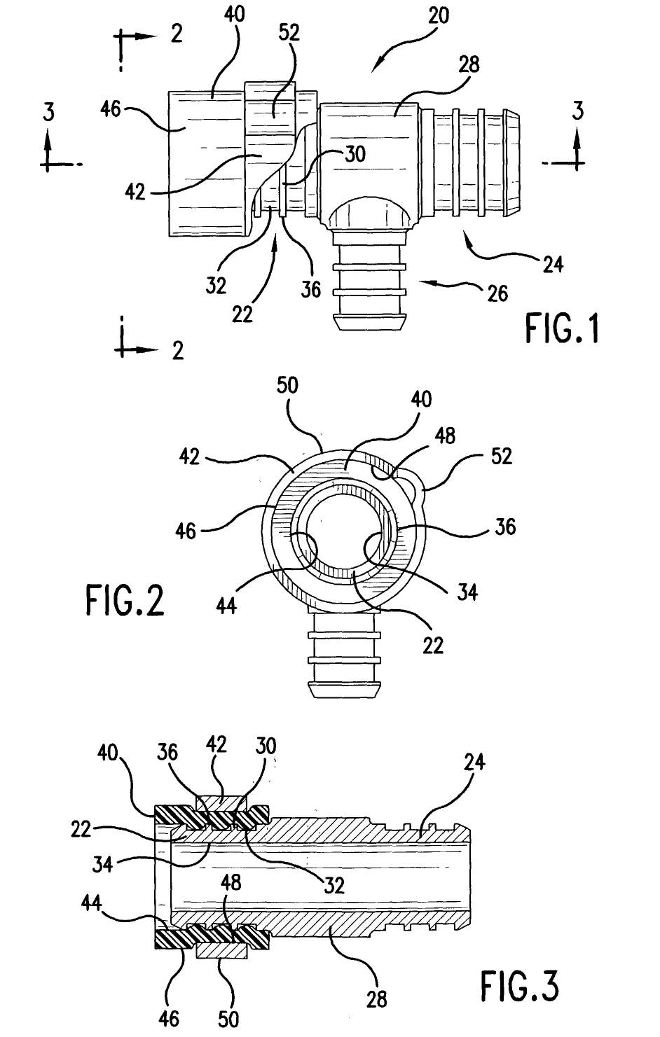

Referring first to FIGS. 1-3, a exemplary brass insert fitting 20 comprises a “tee” connector having two pipe connection members or nipples 22 and 24 sized for 3/4 inch PEX tubing, and a third pipe connection member or nipple 26 having a relatively smaller diameter sized for 1/2 inch PEX tubing. The pipe connection members 22, 24 and 26 are integral with a central body 28. Taking pipe connection member 22 as an example, on its outside the connection member 22 has a series of annular rings 30, which may also be referred to as barbs, with recessed surfaces 32 between the annular rings 30. The connection member 22 has an inner surface 34, commonly referred to as the inside diameter. The maximum radial wall thickness of the connection member 22 is between the inner surface 34 and an outer surface 36, which is coincident with the outer surface of the annular rings 30. As discussed hereinabove, it is important to not nick or otherwise damage the annular rings 30 if the brass insert fitting 20 is to be reused.

Over the pipe connection member 22 is a cut-off end 40 of a plastic pipe secured by (and deformed by) a clamping ring 42. The cut-off end 40 has pipe wall inner and outer surfaces 44 and 46, and the clamping ring 42 has clamping ring inner and outer surfaces 48 and 50. The cut-off end 40 as depicted in FIG. 1 results when a length of plastic pipe, for example comprising PEX tubing, has been installed to the pipe connection member 22 and then, for whatever reason, subsequently cut off, leaving the cut-off end 40. In FIG. 1, the clamping ring 42 comprises a crimped brass ring, but the clamping ring 42 is representative of other forms of clamping ring. Element 52 is a bulge 52 in the crimped brass ring, resulting from an installation process employing a crimping tool, as is described, for example, in the above-referenced “DURA-PEX Installation Manual”. Alternatively, the clamping ring 42 may comprise a resilient plastic ring, such as is employed in the Wirsbo connection system referred to hereinabove. Another alternative is a stainless steel Oetiker clamp. As may be seen in FIG. 3, deformation of the plastic pipe 40 induced by the clamping ring 42 causes the annular rings or barbs 30 to lock into the inner surface 44 of the cut-off end 40 of the plastic pipe.

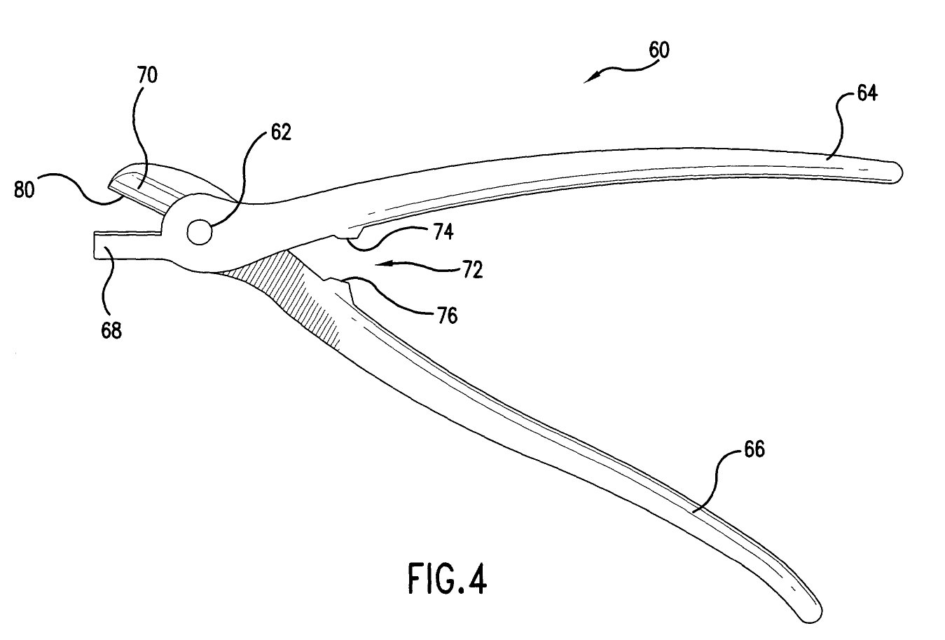

FIG. 4 depicts a first tool 60 embodying the invention for removing the cut-off end 40 of the plastic pipe and the clamping ring 42 from the pipe connection member 22. The tool 60 is in the form of a simple pliers having a single pivot point 62 and a pair of handles 64 and 66. In FIG. 4, the tool 60 is shown in its open position.

The tool 60 has an anvil 68 insertable into the connection member 22 so as to face and bear against the connection member 22 inner surface 34. The tool 60 additionally has a wedged-shaped cutter 70 operatively connected to and opposed to the anvil 68. The cutter 70 is positionable outside the connection member 22 so as to face the outer surface 50 of the clamping ring 42. In the pliers configuration of FIG. 4, with reference to the pivot point 62 the anvil 68 comprises the output arm of a lever also comprising the handle 64 as the input arm. The cutter 70 comprises the output arm of a lever also comprising the handle 66 as the input arm.

The cutter 70 and the anvil 68 are movable relative to each other between the open position illustrated in FIG. 4 in which the cutter 70 and the anvil 68 are spaced from each other so as to clear the radial distance between the connection member inner surface 34 and the clamping ring outer surface 50, and a closed position (represented in FIG. 5) in which the cutter 70 and the anvil 68 are spaced from each other a radial distance (with reference to the circular cross section of the pipe connection member 22) such that the cutter 70 cuts through the clamping ring 42 and approaches but does not substantially cut into the connection member outer surface 36, in particular, the annular rings 30. More particularly, there is a slight gap between the cutter 70 and the outer surface 36. The tool 60 thus includes a stop 72 comprising facing stop surfaces 74 and 76 attached to the handles 64 and 66 respectively, so as to limit relative movement of the cutter 70 and the anvil 68 past the closed position. In the closed position of FIG. 5, there is a gap or space of approximately 1.75 mm between the anvil 68 and the cutter 70. This gap or space is depicted in FIG. 11, referred to again hereinbelow, as dimension “a”.

With reference to FIG. 5, during operation of the tool 60 the anvil 68 is inserted inside the connection member 22. The handles 64 and 66 and squeezed together, until the stop surfaces 74 and 76 contact each other. As a result, the clamping ring 42 in the form of a crimped brass ring is cut through longitudinally, thus opening the ring 42, while the stop 72 prevents the cutter 70 from actually contacting the pipe connection member 22.

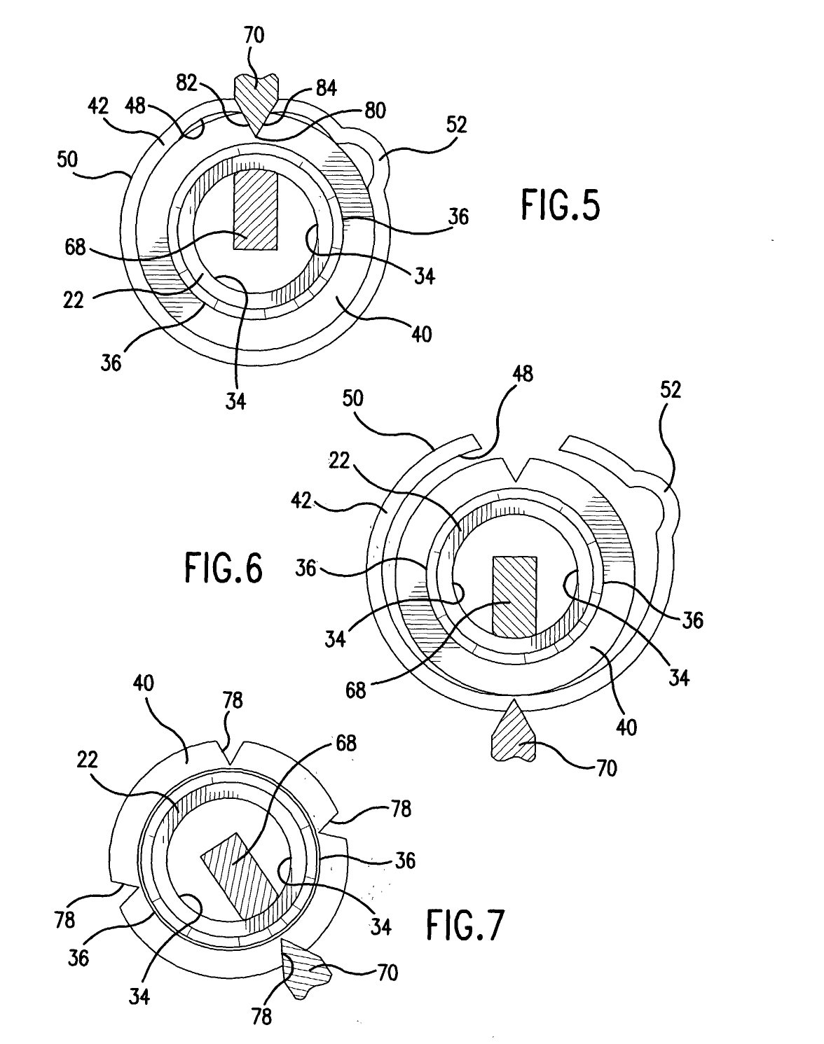

With reference to FIG. 6, next, the handles 64 and 66 are opened, and the connection member 22 and anvil 68 are rotated 1800 with reference to each other. The handles 64 and 66 are again squeezed together. It is not necessary to cut through the clamping ring 42 a second time. Thus, the cutter 70 and the anvil 68 are moved relative to each other towards the closed position so as to longitudinally score but not again cut through the clamping ring 42, which results in the clamping ring 42 being forced open for easy removal.

With reference to FIG. 7, after the clamping ring 42 is removed, the anvil 68 is again inserted into the connection member 22, and employed in a plurality of annular positions to cut into but not entirely through the cut-off end 40 of the plastic pipe, to make several expansion notches 78. Because the cutter 70 is wedge-shaped, the cutter 70 stretches the tubing end 40 as it cuts partially through. This is repeated several times, making partial longitudinal cuts in the tube. This expands the cut-off end of the plastic pipe 40 enough that it can be easily removed.

Again, the stop 72 ensures that the cutter 70 does not come into contact with the brass pipe connection member 22.

The dimensions and geometry of the wedge-shaped cutter 70 are important. Thus, the wedge-shaped cutter 70 has a cutting edge 80, and a pair of inclined surfaces 82 and 84 extending from the cutting edge 80. The inclined surfaces 82 and 84 are an angle within the range of 60° to 90° with reference to each other, and are preferably at an angle of approximately 75°. An angle which is too small results in a cutter 70 which easily cuts the clamping ring 42, but fails to sufficiently expand the plastic tubing in the second portion of operation. An angle which is too great results in a cutter 70 that is quite effective in expanding the plastic tubing for final removal of the cut-off end 40, but does not cut the crimping ring 42.

Related to that, the ultimate width of the cutter 70 must be great enough to provide sufficient wedging action. If the cutter 70 is too thin, there is insufficient wedging action to expand the tubing 40, even with an appropriate angle between the inclined surfaces 82 and 84. As is also depicted in FIG. 11 as dimension “c”, referred to again hereinbelow, a suitable cutter 70 width is 4 mm. A minimum reliable width is estimated to be approximately 1/8 inch (3.175 mm).

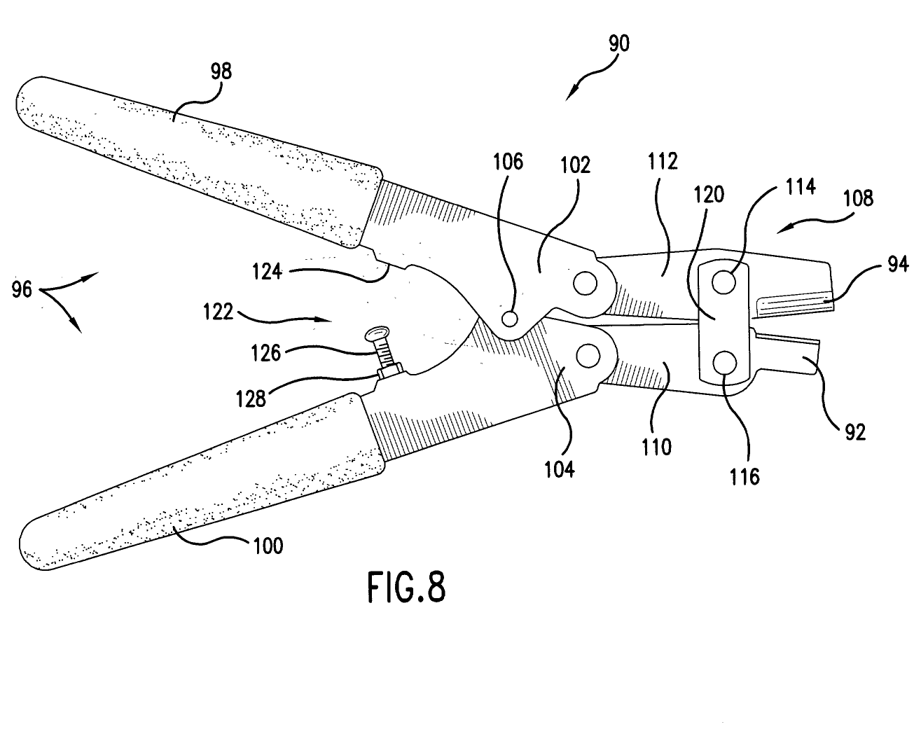

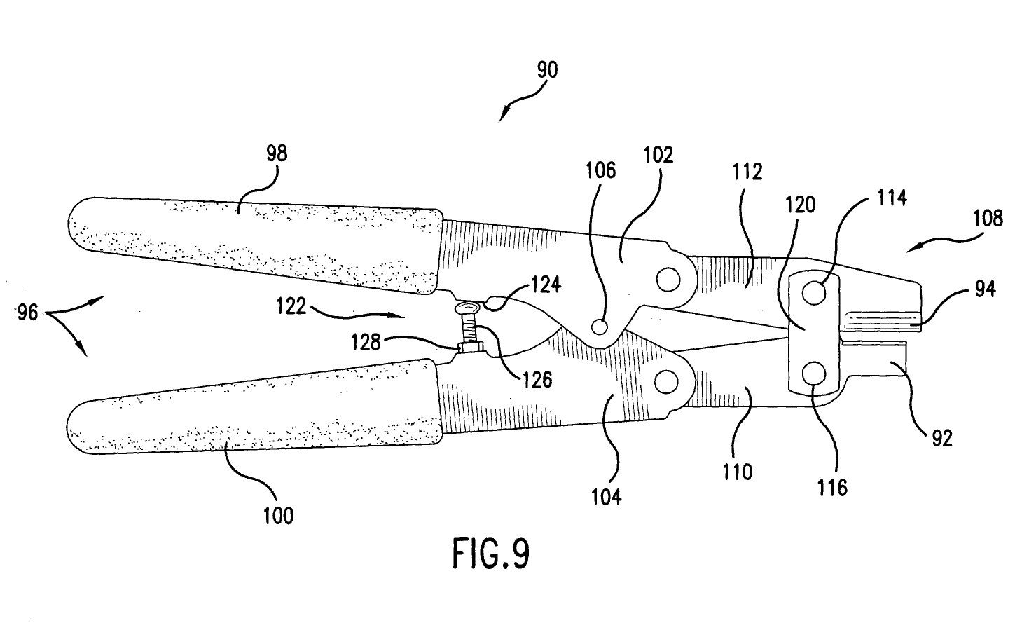

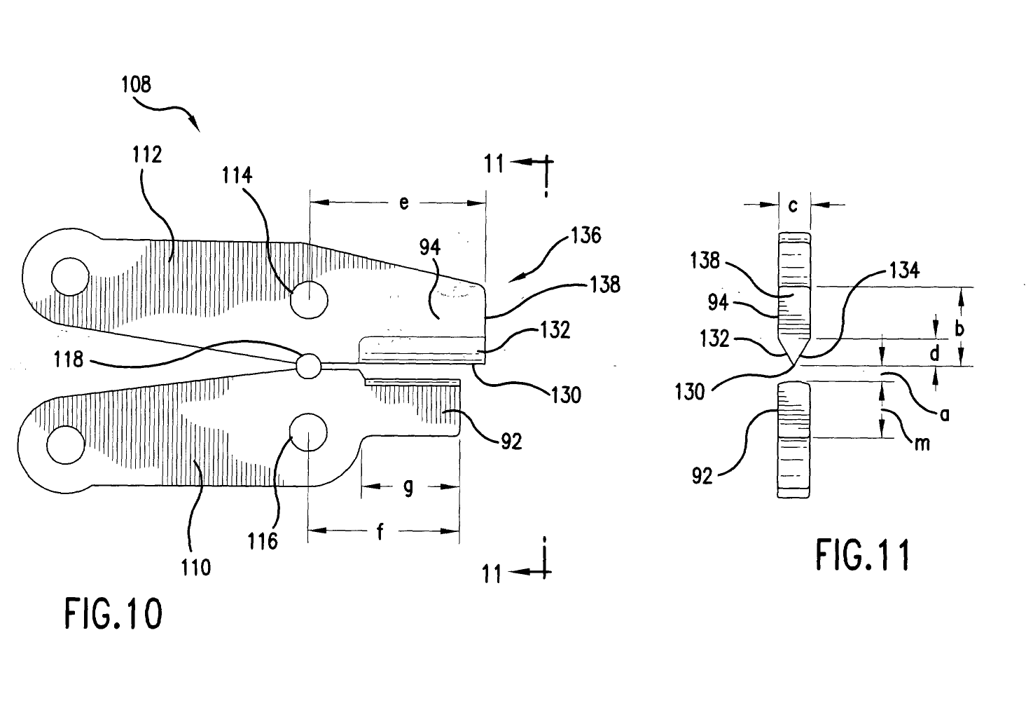

FIGS. 8 and 9 depict another tool 90 embodying the invention, in the form of a compound lever pliers. In addition, FIGS. 10 and 11 show enlarged portions of the tool 60 in isolation. Functionally, the tool 90 of FIGS. 8 and 9 is quite similar to the tool 60 of FIG. 4. Thus, the tool 90 includes an anvil 92 insertable into the connection member 22 so as to face and bear against the connection member inner surface 34, as well as a wedge-shaped cutter 94 positionable outside the connection member 22 so as to face the clamping ring outer surface 50.

Again, the cutter 94 and the anvil 92 are movable relative to each other between an open position (FIG. 8) in which the cutter 94 and the anvil 92 are spaced from each other so as to clear the radial distance between the connection member inner surface 34 and the clamping ring outer surface 50, and a closed position (FIG. 9) in which the cutter 94 and the anvil 92 are spaced from each other a radial distance such that the cutter 94 cuts through the clamping ring 42 and approaches but does not substantially cut into the connection member outer surface 36.

The compound lever pliers tool 90 of FIGS. 6-9 includes a first lever set 96 including handles 98 and 100 as input arms, as well as output arms 102 and 104, pivoting about a first pivot point 106. A second lever set 108 comprises the anvil 92 and cutter 94 as output arms, and corresponding input arms 110 and 112, with respective pivot points 114 and 116, and a locating pivot point 118 (FIG. 8). A transverse strap 120 supports the pivot points 114 and 116.

To maintain a gap of approximately 1.75 mm between the anvil and the cutter 94, by limiting relative movement of the anvil 92 and cutter towards each other past the closed position of FIGS. 9, 10 and 11, a stop 122 is provided. The stop 122 is between a surface 124 on the lever arm comprising the handle 98 and an adjustment screw 126 carried by the lever arm comprising the handle 100. The adjustment screw 126 is threaded into the layer arm comprising the handle 100, and is secured by a lock nut 128. Thus the stop 122 is adjustable. The desired 1.75 mm minimum gap maintained by the stop 122 is indicated as dimension “a” in FIG. 11.

With particular reference to FIGS. 10 and 11, the wedge-shaped cutter 94 has a cutting edge 130, and a pair of inclined surfaces 132 and 134 extending from the cutting edge 130. Again, the inclined surfaces 82 and 84 are an angle within the range of 60° to 90° with reference to each other, and are preferably at an angle of approximately 75°. An angle which is too small results in a cutter 94 which easily cuts the clamping ring 42, but fails to sufficiently expand the plastic tubing in the second portion of the operation. An angle which is too great results in a cutter that is quite effective in expanding the plastic tubing for final removal of the cut-off end 40, but does not cut the crimping ring 42.

FIGS. 10 and 11 depict various dimensional considerations for the anvil 68 and cutter 70 of the embodiment of FIGS. 8-11, dimensioned for connection members or nipples of insert fittings sized for 1/2 inch and 3/4 inch PEX tubing, including test plugs or caps.

The cutter 94 comprises a portion of a cutter jaw 136 having a cutter jaw end 138. In order to prevent improper insertion of the tool 90, that is, to prevent insertion of the cutter 94 rather than the anvil 92 into the connection member 22, the cutter jaw 136, in particular, the cutter jaw end 138, has an extent at least as great as the connection member inside diameter, that is, the diameter defined by the inner surface 34 of the connection member 22. This is dimension “b” in FIGS. 10 and 11. Dimension “b” is 13 mm in the illustrated embodiment.

As in the case of the FIG. 5 cutter 70, the cutter 94 of FIGS. 8-11 has a width “c” which is 4 mm (FIG. 11). The inclined surfaces 132 and 134 of the cutter 94 have an angle of 75° between them, and the cutting wedge length “d” is 2.6 mm.

In order to reach a crimped ring 42 located very near the central body 28, the cutter 44 has an overall length “e” of 27 mm from the locating pivot 118. However, in order to accommodate test cap fittings which have a shorter length inside than outside, the anvil 92 has an overall length “f” of only 21 mm from the locating pivot 118, and an effective length “g” of 15 mm. The anvil 92 height “m” is 8 mm, which fits inside a 1/2 inch fitting.

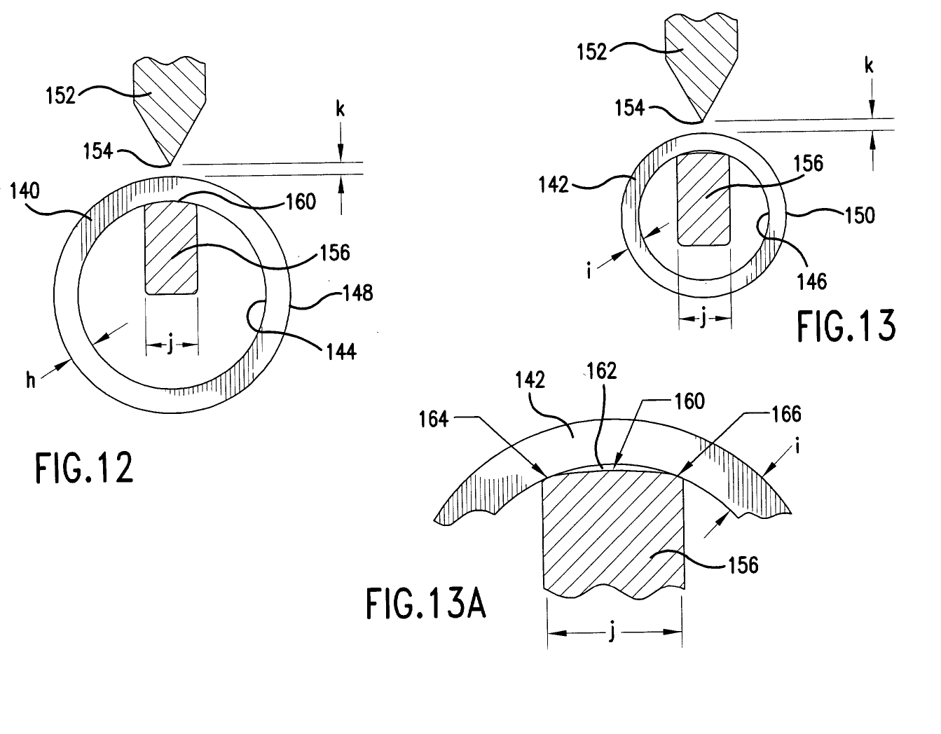

Referring finally to FIGS. 12 and 13, as well as to the enlarged detail of FIG. 13A, with appropriate anvil dimensions, the tool 60 or 90 can fit both a pipe connection member having a relatively larger diameter and a pipe connection member having a relatively smaller diameter. For example, the brass insert fitting 20 of FIG. 1 has two connection members 22 and 24 of relatively larger diameter, and another connection member 26 of relatively smaller diameter.

This is represented in FIGS. 12, 13 and 13A, wherein FIG. 12 depicts the tool 60 or 90 applied to a connection member 140 having a relatively larger diameter, and FIGS. 13 and 13A depict the tool 60 or 90 applied to a connection member 142 having a relatively smaller diameter. The connection members 140 and 142 have respective inner surfaces 144 and 146 (corresponding to the inner surface 34 of the connection member 22 in FIGS. 2, 3 and 5-7), and respective outer surfaces 148 and 150 (corresponding to the outer surface 36 of the connection member 22 in FIGS. 2, 3 and 5-7, which is the outer extent of the annular rings 30). Corresponding radial wall thicknesses are respectively designated “h” and “i”. The maximum radial wall thickness “h” or “i” is, again, the distance between the inner surface 144 or 156 and the outer extent of the annular rings 30, without reference to the recessed surfaces 32. Thickness “h” is greater than thickness “i”.

In FIGS. 12 and 13, a cutter 152 (corresponding to the cutter 70 or 94) having a cutting edge 154, as well as an anvil 156 (corresponding to the anvil 68 or 92) are depicted in the closed position. For convenience of illustration, the cut-off end 40 of the plastic pipe and the clamping ring 42 are not shown in FIGS. 12 and 13.

The anvil 156 has a width “j” which circumferentially spans a portion of the connection member inner surface 144 or 156. The anvil 156 width “j” and profile are selected such that, in the closed position illustrated, the cutter 152, more particularly, the cutting edge 154 thereof, approaches but does not substantially cut into the connection member outer surface regardless of the connection member diameter and corresponding maximum wall radial thickness.

More particularly, a distance “k” between the cutter 152 and the outer surface 148 or 150 is maintained, and this distance “k” is approximately the same notwithstanding the different wall thicknesses “h” and “i” in FIGS. 12 and 13.

If the anvil 156 had a relatively narrow width (“j”) approaching a knife edge, the spacing “k” in FIG. 13 where the pipe connection member 142 has a relatively smaller diameter would be greater than the spacing “k” in FIG. 12 where the connection member 140 has a relatively larger diameter, because the relatively larger diameter connection member 140 has a greater wall thickness “h”.

The anvil 156 has a central member-contacting surface 160 which has a radius that matches the inner surface 144 of the relatively larger diameter connection member 140. Thus, in FIG. 12, the central member-contacting surface 160 conforms to the inner surface 144, with essentially no gap between the anvil 156 and the inner surface 144.

However, in FIGS. 13 and 13A, the geometry is such that there is a gap 162 between the central member-contacting surface 160 and the inner surface 146, which inner surface 146 has a relatively smaller radius. This gap 162 represents compensation for the different wall thicknesses “h” and “i”, and is controlled by selecting the width “j”, as well as the profile of the anvil 156.

To avoid cutting into the inner surface 146, the anvil 156 has edge-contacting surfaces 164 and 166 which have a radius that matches the inner surface 146 of the relatively smaller diameter connection member 142.

While specific embodiments of the invention have been illustrated and described herein, it is realized that numerous modifications and changes will occur to those skilled in the art. It is therefore to be understood that the appended claims are intended to cover all such modifications and changes as fall within the true spirit and scope of the invention.

What is claimed is:

1. A tool for removing a cut-off end of a plastic pipe having pipe wall inner and outer surfaces and a clamping ring having clamping ring inner and outer surfaces from a pipe connection member having a wall with a maximum radial wall thickness between connection member inner and outer surfaces, said tool comprising:
an anvil insertable into the connection member so as to face and bear against the connection member inner surface; and
a wedge-shaped cutter operatively connected to and opposed to said anvil, said cutter positionable outside the connection member so as to face the clamping ring outer surface;
said cutter and said anvil movable relative to each other between an open position in which said cutter and said anvil are spaced from each other so as to clear the radial distance between the connection member inner surface and the clamping ring outer surface, and a closed position in which said cutter and said anvil are spaced from each other a radial distance such that said cutter cuts through the clamping ring and approaches but does not substantially cut into the connection member outer surface.

2. The tool of claim 1, which further comprises a stop for limiting relative movement of said cutter and said anvil towards each other past the closed position.

3. The tool of claim 2, wherein said stop is adjustable.

4. The tool of claim 1, for removing a cut-off end of a plastic pipe and a clamping ring from a pipe connection member in which the inner fitting surface defines an inside diameter, wherein said cutter comprises a jaw including a cutter jaw end having an extent at least as great as the connection member inside diameter so as to prevent improper insertion of said cutter into the pipe connection member.

5. The tool of claim 1, wherein said wedge-shape cutter has a cutting edge and two inclined surfaces extending from said cutting edge at an angle of approximately 75°.

6. The tool of claim 1, wherein said wedge-shape cutter has a cutting edge and two inclined surfaces extending from said cutting edge at an angle within the range of 60° to 90°.

7. The tool of claim 1, which is configured for removing a cut-off end of a plastic pipe comprising PEX tubing and a clamping ring comprising a crimped brass ring from a pipe connection member comprising brass.

8. The tool of claim 1, which is configured for removing a cut-off end of a plastic pipe comprising PEX tubing and a clamping ring comprising a resilient plastic ring from a pipe connection member.

9. The tool of claim 1, which fits at least a pipe connection member having a relatively larger diameter and a pipe connection member having a relatively smaller diameter, the pipe connection member having a relatively larger diameter having a maximum radial wall thickness greater than the maximum radial wall thickness of the pipe connection member having a relatively smaller diameter, wherein
said anvil has a width which circumferentially spans a portion of the connection member inner surface, said anvil width being selected such that, in the closed position, the cutter approaches but does not substantially cut into the connection member outer surface regardless of the connection member diameter and corresponding maximum wall radial thickness.

10. The tool of claim 9, wherein said anvil has a central member-contacting surface which has a radius that matches the inside of the connection member having a relatively larger diameter.

11. The tool of claim 10, wherein said anvil has edge member-contacting surfaces which have a radius that matches the inside of the connection member having a relatively smaller diameter.

12. The tool of claim 1, which comprises a pliers.

13. The tool of claim 1, which comprises a compound lever pliers.

14. A method for removing a cut-off end of a plastic pipe having pipe wall inner and outer surfaces and a clamping ring having clamping ring inner and outer surfaces from a pipe connection member having a wall with a maximum radial wall thickness between connection member inner and outer surfaces, said method comprising:
providing a tool including
an anvil insertable into the connection member so as to face and bear against the connection member inner surface, and
a wedge-shaped cutter operatively connected to and opposed to the anvil, the cutter positionable outside the connection member so as to face the clamping ring outer surface,
the cutter and the anvil movable relative to each other between an open position in which the cutter and the anvil are spaced from each other so as to clear the radial distance between the connection member inner surface and the clamping ring outer surface, and a closed position in which the cutter and the anvil are spaced from each other a radial distance such that the cutter cuts through the clamping ring and approaches but does not substantially cut into the connection member outer surface;
inserting the anvil into the connection member; and
moving the cutter and the anvil relative to each other to the closed position so as to cut through the clamping ring.

15. The method of claim 14, which further comprises:
subsequently opening the cutter and the anvil relative to each other;
rotating the connection member and the anvil relative to each other to a different angular position; and
partially moving the cutter and the anvil relative to each other towards the closed position so as to score but not again cut through the clamping ring and so as to force open the clamping ring.

16. The method of claim 14, which further comprises:
subsequently entirely removing the clamping ring;
inserting the anvil into the connection member; and
partially moving the cutter and the anvil relative to each other towards the closed position so as to cut into but not entirely through the cut-off end of the plastic pipe at a plurality of angular positions so as to expand the cut-off end for removal from the connection member.

17. The method of claim 15, which further comprises:
subsequently entirely removing the clamping ring;
inserting the anvil into the connection member; and
partially moving the cutter and the anvil relative to each other towards the closed position so as to cut into but not entirely through the cut-off end of the plastic pipe at a plurality of angular position so as to expand the cut-off end for removal from the connection member.

18. The method of claim 14, wherein said step of providing a tool comprises providing a tool which further includes a stop for limiting relative movement of the cutter and the anvil past each other towards the closed position.

19. The method of claim 14, wherein said step of providing a tool comprises providing a tool in the form of a pliers.

20. The method of claim 14, wherein said step of providing a tool comprises providing a tool in the form of a compound lever pliers.

21. The method of claim 14, which is for removing a cut-off end of a plastic pipe comprising PEX tubing and a clamping ring comprising a crimped brass ring from a pipe connection member comprising brass.

22. The method of claim 14, which is for removing a cut-off end of a plastic pipe comprising PEX tubing and a clamping ring comprising a resilient plastic ring from a pipe connection member.
